(19) United States
(12) Patent Application Publication
(10) Pub. No.: US 2017/0080361 A1
(43) Pub. Date: Mar. 23, 2017

(54) STRAINERS

(71) Applicant: DELAVAN INC, West Des Moines, IA (US)

(72) Inventors: Jason A. Ryon, Carlisle, IA (US); Brett A. Pfeffer, Granger, IA (US); Mark A. Caples, Ankeny, IA (US)

(21) Appl. No.: 14/858,762

(22) Filed: Sep. 18, 2015

(51) Int. Cl. B01D 29/03; F02C 7/22; B01D 35/00

(52) U.S. Cl. CPC B01D 29/031; B01D 35/005; F02C 7/22; F05D 2220/32

(57) ABSTRACT

A strainer has a strainer body with a width and a height. The height of the strainer body is smaller than the width of the strainer body. The strainer body has a serpentine cross-sectional profile to provide rigidity and straining area. A fuel injector includes a strainer as described and a nozzle body with a fuel circuit defined therein. The strainer is integrally coupled to the nozzle body and is in fluid communication with the fuel circuit to remove entrained particulate from fuel traversing the strainer prior to the fuel reaching the fuel circuit.

### BACKGROUND OF THE INVENTION

1. Field of the Invention

The present disclosure relates to fluid systems, and more particularly to strainers for removing particulate entrained in fluid flow through fluid systems.

2. Description of Related Art

Aircraft commonly employ fluid systems to provide fluid flows to devices like actuators, heat exchangers, and/or combustors. Since fluid traversing such fluid systems can include entrained particulate material, some fluid systems employ strainers to arrest entrained particulate material. Strainers typically include a straining element with flow orifices sized to prevent entrained particulate from traversing the strainer. Such orifices typically prevent entrained material from being carried into relatively fine features, such as mechanical devices such as valves or slots and holes defined within downstream structures, where the entrained material could otherwise hinder mechanical or fluidic operation. Some strainers have shapes where a portion of the straining element extends along a portion of the fluid flow path, like a top hat shape. Such shapes allow for the straining element to present suitable straining area to fluid traversing the straining element while limiting the pressure drop associated with the strainer. The height of the straining element can influence the packaging of the fluid system components and can necessitate the use of housings with an axial height corresponding to the axial height of the straining element.

Such conventional strainers, systems incorporating such strainers, and methods of making strainers have generally been considered satisfactory for their intended purpose. However, there is still a need in the art for improved strainers. The present disclosure provides a solution for this need.

### SUMMARY OF THE INVENTION

A strainer has a strainer body defining a flow axis with a width and a height. The height of the strainer body extends in the direction of the flow axis and is smaller than the width of the strainer body. Flow passages extend through the strainer body, and the strainer body has a serpentine cross-sectional profile to provide rigidity and straining area.

In certain embodiments, the strainer body can define annular corrugations that extend about a flow axis of the strainer body. The corrugations can circumferentially extend about the flow axis at different respective radial offsets relative to the flow axis. One of the corrugations of the strainer body can define the periphery of the strainer body. The strainer body can include a mesh structure, a perforated plate, or layers integrally fused with one another.

In accordance with certain embodiments, the serpentine cross-sectional profile can span the height of the strainer body. The serpentine cross-sectional profile can span the width of the strainer body. The serpentine cross-sectional profile can span both the width and the height of the strainer body. The serpentine cross-sectional profile can span the entire height and/or the entire width of the strainer body. Flow passages can extend through the corrugations. The flow passages can define respective passage axes that are parallel relative to the flow axis, orthogonal to the flow axis, and/or oblique relative to the flow axis.

It is also contemplated that, in accordance with certain embodiments, the serpentine cross-sectional profile can include arcuate segments connected by a planar segment. Flow passages can extend through the arcuate segments and the planar segment. Flow passages extending through the arcuate segments can have flow areas and flow area shapes that differ from flow areas and flow area shapes of flow passages extending through the planar segment. Flow passages extending through the arcuate segments can have predetermined flow areas and flow area shapes that are the same in flow passages that extend through the arcuate segments and in flow passages that extend through the planar segment. For example, flow passages extending through the arcuate segments can have flow areas and/or flow area shapes that are identical to flow areas and/or flow shapes of flow passages extending through the planar segment.

A fuel injector for a gas turbine engine includes a nozzle body, a feed arm coupled to the nozzle body, and a strainer housing with a strainer as described above coupled to the feed arm. The strainer is integral with the strainer housing and is fluid communication with a fluid circuit defined within the feed arm and nozzle body for arresting entrained particulate within fluid traversing the strainer prior to the particulate reaching the fluid circuit.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1A is a perspective view of an exemplary embodiment of a strainer constructed in accordance with the present disclosure, showing a strainer body with corrugations;

FIG. 1B is a perspective view of an exemplary embodiment of the strainer of FIG. 1A, showing the strainer in relation to a top hat-shaped strainer;

FIG. 2 is a cross-sectional side view of the strainer of FIG. 1A, showing a serpentine cross-sectional profile of the strainer body;

FIGS. 3A-3C are schematic views of the strainer of FIG. 1A according to embodiments, showing segments of the serpentine cross-sectional profile of the strainer body; and

FIG. 4 is a schematic view of the strainer of FIG. 1A, showing the strainer integrally disposed within a strainer housing that is coupled to a fuel injector feed arm.

### DETAILED DESCRIPTION OF THE PREFERRED EMBODIMENTS

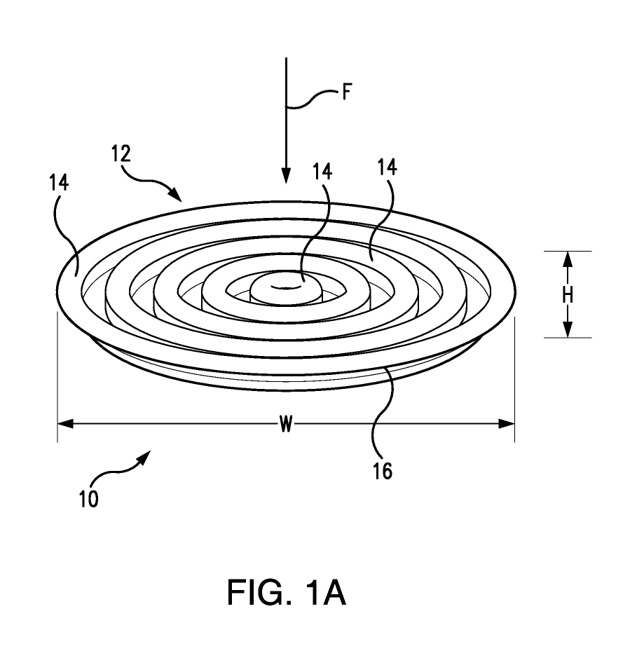

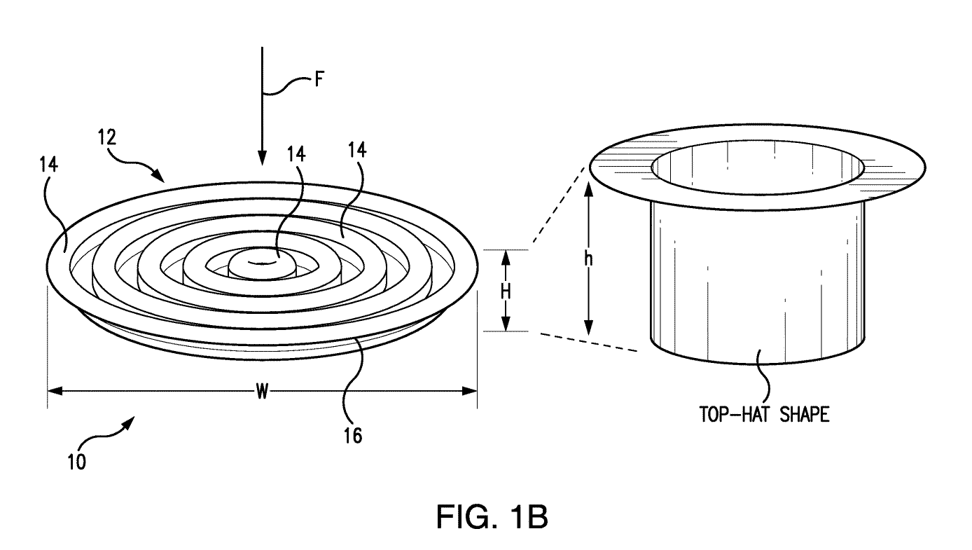

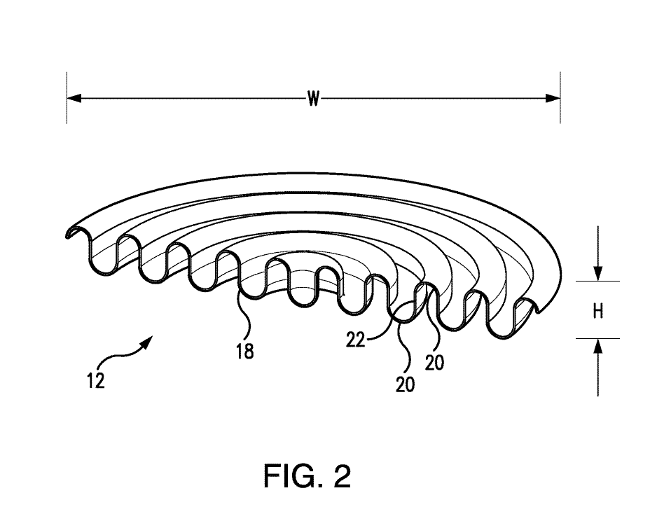

Reference will now be made to the drawings wherein like reference numerals identify similar structural features or aspects of the subject disclosure. For purposes of explanation and illustration, and not limitation, a partial view of an exemplary embodiment of a strainer in accordance with the disclosure is shown in FIG. 1A and is designated generally by reference character 10. Other embodiments of strainers and fuel injectors with strainers in accordance with the disclosure, or aspects thereof, are provided in FIGS. 2-4, as will be described. The systems and methods described herein can be used fluid systems, such as in fuel injectors for aircraft engines.

Referring to FIG. 1A and FIG. 1B, a strainer is generally referred to with reference numeral 10. Strainer 10 includes a strainer body 12. A flow axis F extends through strainer body 12. A plurality of corrugations 14 extend about flow axis F. Respective corrugations 14 have radial offsets relative to flow axis F that differ from one another. In the illustrated example strainer body 12 includes five (5) corrugations extending about flow axis F. As will be appreciated by those of skill in the art in view of the present disclosure, strainer body 12 can have fewer than five (5) corrugations 14, more than five (5) corrugations 14, as suitable for an intended application. As will also be appreciated, a radially outer corrugation 14 can define a periphery 16 of strainer body 12.

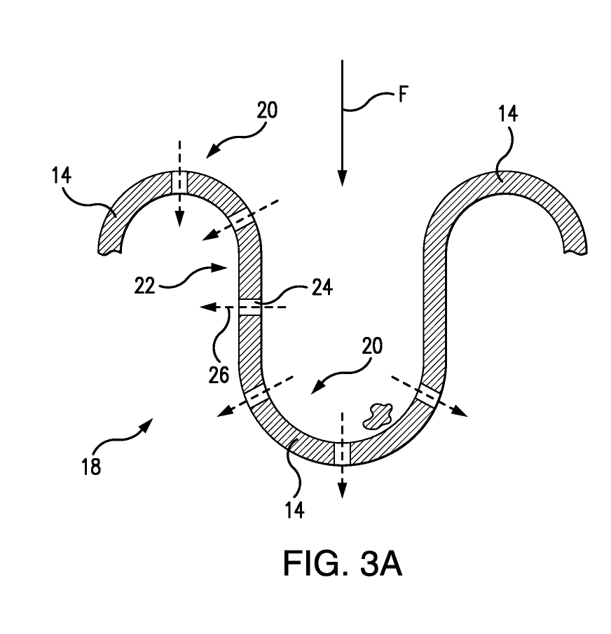

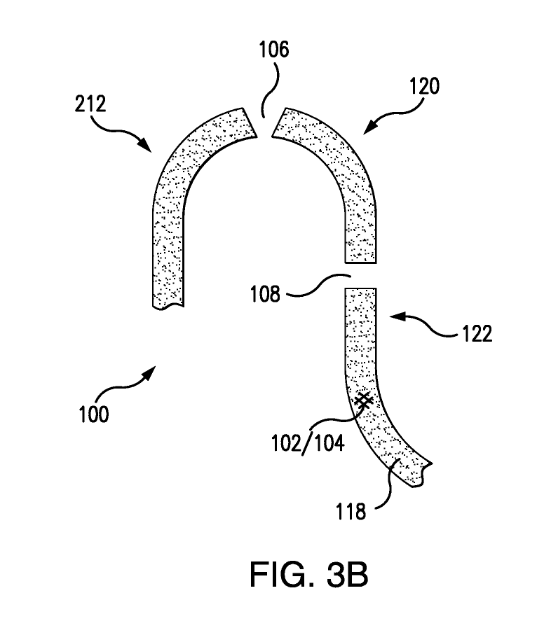

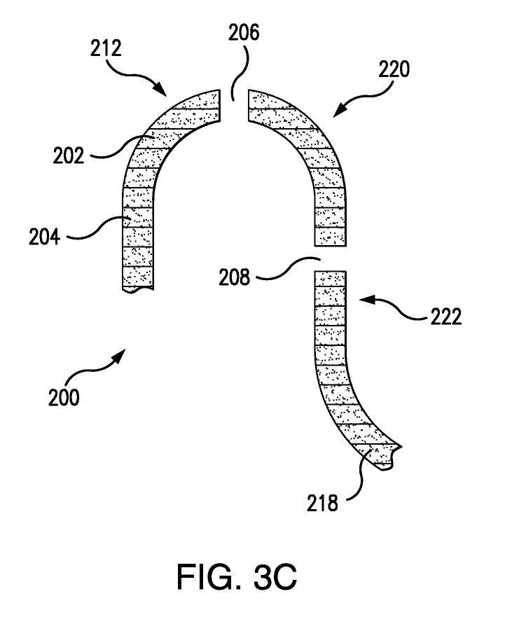

Strainer body has a width W and a height H. In the illustrated exemplary embodiment, height H of strainer body 12 is smaller than width W of strainer body 12 such that strainer body 12 is disk-shaped, reducing the footprint of the assembly incorporating strainer 10. Corrugations 14 provide increased surface area within which flow passages can be defined through strainer body 12. This allows strainer 10 to present substantially the same flow area and resistance to fluid traversing strainer body 12 as strainer with a larger height, e.g. a top hat-shaped strainer (shown in dashed outline on the right-hand side of FIG. 1B). It is contemplated that strainer 10 can have a height H that is about 20% that of a top-hat shaped strainer, reducing the size of a housing 50 (shown in FIG. 3) within which strainer 10 is disposed. Corrugations 14 can also provide rigidity to strainer body 12 such that strainer 10 can resist pressure applied thereto by fluid traversing strainer 10. As will appreciated by those of skill in the art in view of the present disclosure, in certain embodiments, height H may be greater that width W to provide added straining area and/or to lengthen the interval between strainer replacements in certain applications.

With reference to FIG. 2, strainer body 12 is shown in lateral cross-section. Strainer body 12 includes a serpentine cross-sectional profile 18. Cross-sectional profile 18 spans height H of strainer body 12. Cross-sectional profile 18 also spans width W of strainer body 12. As illustrated, corrugations 14 along both an upper and lower surface of strainer body 12 such that serpentine cross-sectional profile 18 spans the entire height H and width W of strainer body 12. In the illustrated exemplary embodiment corrugations are disposed on a radial pitch that is uniform, i.e. the corrugation adjacent to the innermost corrugation has a radial offset that is twice that of the innermost corrugation. This is for illustration purposes only and non-limiting. In embodiments, adjacent corrugations 14 may be asymmetrically offset from one another on a pitch that varies across the width of the strainer body.

Cross-sectional profile 18 includes a plurality of arcuate segments 20 and a plurality of planar segments 22. One or more of arcuate segments 20 have a convex profile relative to the top of FIG. 2, and one or more of arcuate segments 20 have a concave profile relative to the top of FIG. 2. Respective planar segments 22 couple adjacent arcuate segments 22 with convex and concave profiles. Planar segments 22 may extend along or be substantially parallel to flow axis F (shown in FIG. 1).

With reference to FIG. 3A, a portion of serpentine cross-sectional profile 18 is shown. Flow passages 24 extend through corrugations 14. Flow passages 24 define passage axes 26 that, based on the location of a respective flow passage 24, may be parallel with flow axis F, oblique relative to flow axis F, or substantially orthogonal relative to flow axis F.

With reference to FIG. 3B, a strainer 100 is shown. Strainer 100 is similar to strainer 10, and additionally includes a strainer body 112 formed from a mesh structure 102 or a perforated plate 104 that is formed into the illustrated geometry using a piece part operation, such as stamping and/or crimping. As a consequence of the operation(s) used to form strainer body 112, flow passages extending through strainer body 112 may have shapes and/or flow areas that differ from one another according the influence of the piece-part operation on a given region of strainer body 112. For example, a flow passage 106 (shown schematically) located on an arcuate segment 112 of serpentine cross-sectional profile 118 may have a flow area and/or shape that differs from that of a flow passage 108 (shown schematically) located on a planar segment 122 of serpentine cross-sectional profile 118.

With reference to FIG. 3C, a strainer 200 is shown. Strainer 200 is similar to strainer 10, and additionally includes a strainer body 212 formed from a plurality of layers fused to one another in a layer wise manner, such as with an additive manufacturing technique. In this respect strainer 200 includes a first layer 202 fused to a second layer 204. The layer wise composition of strainer body 212 enables flow passages extending through strainer body 212 to have a predetermined shape and/or flow area irrespective of where a given flow passage is located on strainer body 212, and decouples the shape of flow passages from piece part operations that could otherwise be used to form a strainer with the illustrated geometry. For example, a flow passage 206 (shown schematically) located on an arcuate segment 212 of serpentine cross-sectional profile 218 may have the same flow area and/or shape as a flow passage 208 (shown schematically) located on a planar segment 222 of serpentine cross-sectional profile 218.

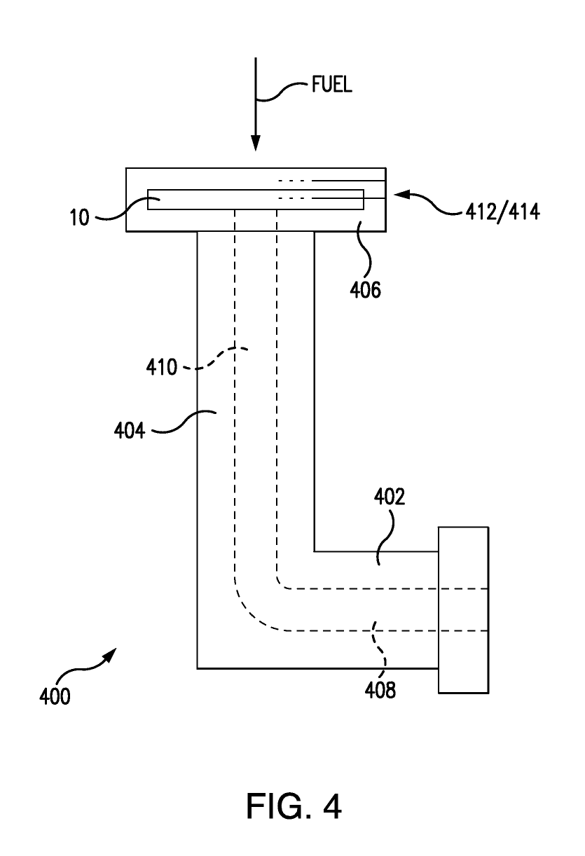

With reference to FIG. 4, a fuel injector 400 for a gas turbine engine is shown. Fuel injector 400 includes a nozzle body 402 coupled to a feed arm 404. A strainer housing 406 is coupled to feed arm 404. Nozzle body 402 has defined within its interior a fuel circuit 408. Fuel circuit 408 is in fluid communication with a fuel conduit 410 disposed within feed arm 404. A strainer 10 is disposed within strainer housing 406 and is in fluid communication with fuel circuit 408 of nozzle body 402 through fuel conduit 410. Strainer housing 406 and strainer 10 are integral with one another, both strainer housing 406 and strainer 10 sharing a first layer 412 fused to a second layer 414 to form an integral (i.e. unitary) structure that is in turn removable fixed to the feed arm 404. This allows for replacing strainer 10 and strainer housing 406 as a unit without disturbing the arrangement of nozzle body 402 in relation to a gas turbine engine.

The methods and systems of the present disclosure, as described above and shown in the drawings, provide for strainers with superior properties including reduced height for a given strainer width and effective straining area when compared with traditional strainers. While the apparatus and methods of the subject disclosure have been shown and described with reference to preferred embodiments, those skilled in the art will readily appreciate that changes and/or modifications may be made thereto without departing from the scope of the subject disclosure.

1. A strainer, comprising:
a strainer body having a height, a width, and a serpentine cross-sectional profile,
wherein the height of the strainer body defines a plurality of flow passages extending therethrough to strain fluid traversing the strainer body.

2. A strainer as recited in claim 1, wherein the height of the strainer body is smaller than the width of the strainer body.

3. A strainer as recited in claim 1, wherein the strainer body defines a plurality of annular corrugations extending about a flow axis extending through the strainer body.

4. A strainer as recited in claim 1, wherein the strainer body defines six annular corrugations extending about a flow axis extending through the strainer body.

5. A strainer as recited in claim 1, wherein the serpentine cross-sectional profile spans both the height of the strainer body and the width of the strainer body to provide straining area and rigidity to the strainer body.

6. A strainer as recited in claim 1, wherein the serpentine cross-sectional profile spans the entire height of the strainer body.

7. A strainer as recited in claim 1, wherein the serpentine cross-sectional profile spans the entire width of the strainer body.

8. A strainer as recited in claim 1, wherein the serpentine cross-sectional profile includes a plurality of arcuate segments and at least one planar segment coupling the arcuate segments.

9. A strainer as recited in claim 8, wherein at least one of the plurality of arcuate segments has flow passages extending therethrough.

10. A strainer as recited in claim 8, wherein the at least one planar segment has flow passages extending therethrough.

11. A strainer as recited in claim 8, wherein the planar segment and the arcuate segments each include flow passages, wherein the flow passages of the planar segment have flow areas that are equivalent to flow areas of the flow passages of the arcuate segment.

12. A strainer as recited in claim 8, wherein the planar segment and the arcuate segments each include flow passages, wherein the flow passages of the planar segment have flow areas that are differ than flow areas of the flow passages of the arcuate segment.

13. A strainer as recited in claim 1, wherein the strainer body includes mesh, a perforated plate, or a plurality of fused layers.

14. A strainer as recited in claim 1, wherein the strainer has flow passages with uniform shape and flow area distributed on both arcuate and planar segments of the serpentine cross-sectional profile.

15. A fuel injector for a gas turbine engine, comprising:
a nozzle body;
a feed arm coupled to the nozzle body; and
a strainer housing with a strainer as recited in claim 1 disposed therein and coupled to the feed arm, wherein the strainer is integral with the strainer housing and is in fluid communication with a fuel circuit extending through the feed arm and the nozzle body.
